(19) United States
(12) Patent Application Publication
(10) Pub. No.: US 2023/0332981 A1
(43) Pub. Date: Oct. 19, 2023

(54) Single Or Multi-Coupled Fault Test System And Fault Diagnosis Method For Rotor System

(71) Applicant: CHN ENERGY DADU RIVER REPAIR & INSTALLATION CO., LTD, Chengdu (CN)

(72) Inventors: Bing QIAN, Chengdu (CN); Zhiguo FENG, Chengdu (CN); Yinhui CAI, Chengdu (CN); Yinkang RAN, Chengdu (CN); Qiang DING, Chengdu (CN); Bin SHE, Chengdu (CN)

(21) Appl. No.: 17/714,642

(22) PCT Filed: Jul. 9, 2021
(86) PCT No.: PCT/CN2021/105473

§ 371 Date: Apr. 6, 2022

(30) Foreign Application Priority Data
Oct. 15, 2020 (CN) 202011101076.5

(51) Int. Cl. G01M 13/028; G01M 13/025

(52) U.S. Cl. CPC G01M 13/028; G01M 13/025

(57) ABSTRACT

The present disclosure provides a single or multi-coupled fault test system and fault diagnosis method for a rotor system. With the modular design, and by setting different rotating conditions and structural forms of the flexible rotor system for simulation on operation states and fault types of the rotor system, the present disclosure can implement the simulation test of the rotor system in different fault conditions and can ensure the accuracy of the test performance in the simulation test. With the establishment of the fault determination models of the rotor system in the different fault conditions, the present disclosure can accurately predict and warn the fault of the rotor system, accurately analyze the fault type, and ensure the operational reliability of the rotor system.

### CROSS REFERENCE TO RELATED APPLICATION

This patent application claims the benefit and priority of Chinese Patent Application No. 202011101076.5, filed on Oct. 15, 2020, the disclosure of which is incorporated by reference herein in its entirety as part of the present application.

### TECHNICAL FIELD

The present disclosure relates to the technical field of fault tests on rotating machines, and in particular, to a single or multi-coupled fault test system and fault diagnosis method for a rotor system.

### BACKGROUND ART

Rotating machines can be seen everywhere in our daily life, and their faults have received widespread attentions. The faults of the rotating machines will cause the undesirable product quality or even suspend the production and affect the whole production process. Predictive maintenance based on state monitoring, which is implemented by finding faults beforehand and taking corresponding measures, is envisioned as the effective means to ensure the normal operation of the devices and prevent the economic losses.

### SUMMARY

In view of the shortages of the prior art, an objective of the present disclosure is to provide a single or multi-coupled fault test system and fault diagnosis method for a rotor system.

The above-mentioned objective of the present disclosure is implemented with the following technical solutions: A single or multi-coupled fault test system for a rotor system includes: a test platform, configured to test performance of a rotating shaft, and including a mounting platform, a motor, a coupling, a bearing seat, a sliding bearing, a balancing disc, a heating jacket, a brake and an impeller, where the coupling is a film coupling and is configured to connect the rotating shaft with the motor and the brake; the sliding bearing is provided on the bearing seat, the sliding bearing includes a circular or elliptical bearing shell, the bearing shell includes an upper bearing shell and a lower bearing shell that are opposite to each other, a groove is formed at a bottom of the lower bearing shell, the groove is provided horizontally along an axial direction of the lower bearing shell and provided symmetrically relative to a center of the lower shaft shell, a length of the groove is ½-⅔ times a length of the lower shaft shell, two sides of the groove form an included angle of 90° in a width direction relative to a center of the sliding bearing, and the groove is 0.2-0.5 mm deep; and the upper bearing shell and the lower bearing shell each are of a combined structure, the upper bearing shell and the lower bearing shell each include an initial section, an end filling section and/or at least one middle filling section, and the middle filling section is cooperatively provided between the initial section and the end filling section;
a data acquisition system, configured to acquire operation state data of the rotating shaft, and including a multi-channel data acquisition unit, a rotational speed sensor for detecting a rotational speed of the motor, a vibration sensor for acquiring vibration data of the rotating shaft and a displacement sensor assembly for testing a displacement of the rotating shaft in an X direction and a Y direction; and
a control system, configured to receive the data acquired by the data acquisition system, analyze and process the data, and control the test platform according to an analysis result.

As a further improvement to the above technical solutions, a connection locating structure may be cooperatively provided among the initial section, the end filling section and the middle filling section; the initial section, the end filling section and the middle filling section may be connected with each other through the connection locating structure; the connection locating structure may include limiting grooves and connection clamping pieces that are respectively arranged at one end of the initial section and at one end of the end filling section as well as at two ends of the middle filling section; the limiting grooves may be oppositely arranged on inner and outer sides of the bearing shell; the connection clamping pieces each may include two opposite clamping pieces; and the clamping pieces may be correspondingly and cooperatively arranged in the limiting grooves.

The present disclosure further relates to a single or multi-coupled fault diagnosis method for a rotor system, including the following steps:
1) testing operation state data of the rotor system in a normal condition and different fault conditions, drawing an operation graph, and establishing different fault state determination models, including a rotating shaft crack fault determination model, a shafting thermal deformation fault determination model, and a coupling crack fault determination model, where
the establishing the rotating shaft crack fault determination model includes:
Z1: mounting a normal uncracked rotating shaft on a test platform, and providing a vibration sensor and displacement sensors, where the vibration sensor is magnetically fixed on a bearing seat, two displacement sensors are arranged at each sampling site, and the two sensors are respectively arranged along a horizontal direction and a vertical direction, and configured to detect displacement data of the rotating shaft in an X direction and a Y direction;
Z2: starting a motor, accelerating the rotating shaft at a constant speed to a critical rotational speed of a test system, and acquiring vibration data of the sensor upon a stable rotational speed;
Z3: adjusting a torque of a brake, uniformly adjusting the rotational speed of the rotating shaft, keeping the test system at about a half of the critical rotational speed, adjusting the rotational speed of the rotating shaft at a variable ΔV, and acquiring vibration data at different rotational speeds;
Z4: mounting a cracked shaft, which is prefabricated with a crack, on the test platform and repeating steps Z2 and Z3; and
Z5: analyzing acquired data to obtain a vibration curve and an axis trajectory curve of each of the normal shaft and the cracked shaft, and comparing the normal shaft with the cracked shaft in terms of the vibration curve and the axis trajectory curve, thereby establishing the rotating shaft crack fault determination model;
the establishing the shafting thermal deformation fault determination model includes:
R1: mounting a rotating shaft on the test platform, and providing a heating jacket on a middle of the rotating shaft, where the heating jacket has a heating length of 100-200 mm, a 0.5-1 mm clearance is formed between the heating jacket and the rotating shaft, and a high-temperature resistant insulating oil is filled in the clearance;
R2: respectively providing a data sampling site at two ends and a heating section of the rotating shaft, and respectively providing a vibration sensor and displacement sensors at the sampling site, where the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction;
R3: starting the motor and the heating jacket, keeping the rotating shaft rotating for 15-20 min continuously after the heating jacket is heated to a preset temperature, and heating the heating section of the rotating shaft to a preset temperature;
R4: acquiring vibration and displacement data of the rotating shaft, and measuring a deformation of the heating section on the rotating shaft;
R5: adjusting a temperature setting of the heating jacket, setting an initial temperature T1, adjusting a heating temperature with a temperature gradient ΔT as a variable, and repeating steps R3 and R4; and
R6: analyzing acquired data to obtain deformations, vibrations and axis trajectory curves of the rotating shaft at different temperatures, thereby establishing the shafting thermal deformation fault determination model; and
the establishing the coupling crack fault determination model includes:
L1: mounting a rotating shaft on the test platform, the rotating shaft being connected with an output shaft of the motor through a normal coupling;
L2: respectively providing a data sampling site at two ends of the rotating shaft and a position where the coupling is provided; respectively providing a vibration sensor and displacement sensors at the sampling site, where the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction; and providing a rotational speed sensor between the output shaft of the motor and the coupling, so as to acquire a rotational speed signal and perform feedback control on the rotating shaft of the motor;
L3: starting the motor, accelerating the rotating shaft at a constant speed to the critical rotational speed of the test system, and acquiring detection data upon a stable rotational speed;
L4: adjusting a torque of the brake, uniformly adjusting the rotational speed of the rotating shaft, adjusting the rotational speed of the rotating shaft at a variable ΔV until the test system is kept at about the half of the critical rotational speed, and acquiring data at different rotational speeds;
L5: connecting the rotating shaft and the output shaft of the motor with a crack prefabricated coupling, and repeating steps L2, L3 and L4; and
L6: analyzing acquired data to obtain a vibration curve and an axis trajectory curve of each of the normal shaft and the crack prefabricated coupling, and comparing the normal shaft with the crack prefabricated coupling in terms of the vibration curve and the axis trajectory curve, thereby establishing the coupling crack fault determination model; and
2) acquiring an operation parameter of the rotor system in real time when the rotor system operates, comparatively analyzing the operation parameter with the established fault state determination models, warning a fault of the rotor system, and determining and predicting a fault type of the rotor system.

To sum up, the present disclosure has the following beneficial effects:
1) With the modular design, and by setting different rotating conditions and structural forms of the flexible rotor system for simulation on operation states and fault types of the rotor system, the present disclosure can implement the simulation test of the rotor system in different fault conditions and can ensure the accuracy of the test performance in the simulation test.
2) The groove structure on the bearing shell of the sliding bearing increases the specific pressure between the journal of the main shaft and the bearing shell and further increases the relative eccentricity of the journal in the bearing shell, and the bearing shell is of the combined structure, all of which can effectively improve the operational stability of the rotor system, ensure the accuracy of test data of the fault test system, and provide stable and reliable data bases for establishment of the fault determination models.
3) With the establishment of the fault determination models of the rotor system in the different fault conditions, the present disclosure can accurately predict and warn the fault of the rotor system, accurately analyze the fault type, and ensure the operational reliability of the rotor system.

### BRIEF DESCRIPTION OF THE DRAWINGS

To describe the technical solutions in embodiments of the present disclosure or in the prior art more clearly, the accompanying drawings required in the embodiments will be briefly described below. Apparently, the accompanying drawings in the following description show merely some embodiments of the present disclosure, and other drawings can be derived from these accompanying drawings by a person of ordinary skill in the art without creative efforts.

FIG. 1 is a schematic structural view of a test platform according to the present disclosure;

FIG. 2 is a cross-sectional schematic view of a groove in a bearing shell according to the present disclosure;

FIG. 3a) is a schematic view of a combined structure of a bearing shell according to the present disclosure;

FIG. 3b) is a right structural view of an initial section of a bearing shell according to the present disclosure; and

FIG. 3c) is a left structural view of a middle filling section of a bearing shell according to the present disclosure.

In the figures: 1. motor, 2. coupling, 3. bearing seat, 4. sliding bearing, 401. lower bearing shell, 402. groove, 403. initial section, 404. end filling section, 405. middle filling section, 406. connection clamping piece, 407. limiting groove, 5. balancing disc, 6. heating jacket, 7. brake, 8. impeller, 9. rotating shaft, 10. sensor holder, 11. heating jacket holder, and 12. impeller shaft.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by the person of ordinary skill in the art on the basis of the embodiments of the present invention without creative efforts shall fall within the protection scope of the present invention.

An objective of the present disclosure is to provide a single or multi-coupled fault test system and fault diagnosis method for a rotor system, to solve the problems in the prior art.

To make the above objectives, features, and advantages of the present disclosure clearer and more comprehensible, the present disclosure will be further described in detail below with reference to the accompanying drawings and the specific embodiments.

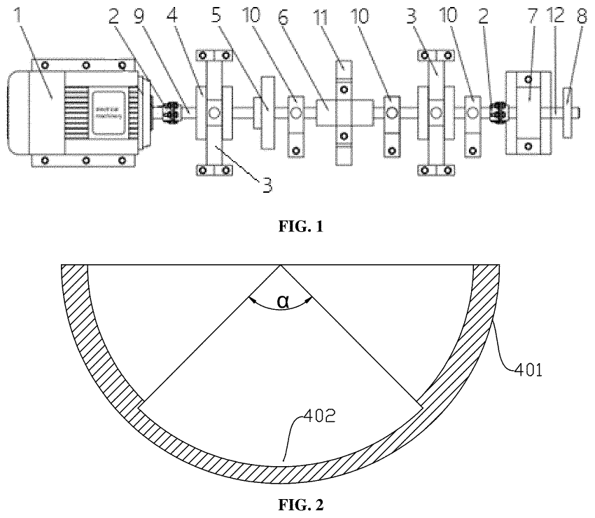

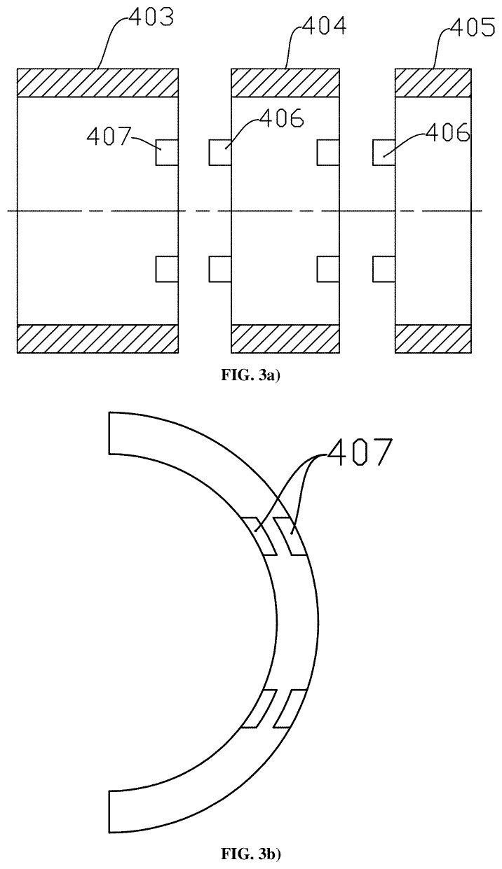

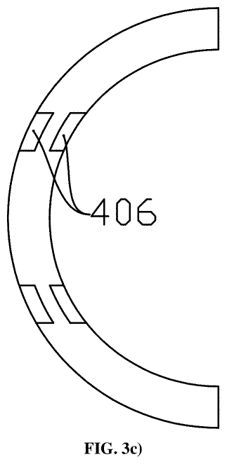

As shown in FIG. 1, the fault test system in the embodiment includes: a test platform, a data acquisition system, and a control system.

The test platform is configured to test performance of a rotating shaft, and includes a mounting platform, a motor 1, a coupling 2, a bearing seat 3, a sliding bearing 4, a balancing disc 5, a heating jacket 6, a brake 7 and an impeller 8.

The coupling 2 is a film coupling and is configured to connect the rotating shaft with the motor and the brake. The film coupling is applied to the connection between the motor and the transmission shaft in situations imposing high requirements on the accuracy, such as misalignment and decentration in the radial loading process. It can compensate radial, angular and axial deviations with the elasticity and can further withstand a certain high temperature.

The balancing disc 5 can be quickly disassembled and moved for adjustment, and has a diameter of 140 mm and a thickness of 25 mm. There are 20 holes uniformly arranged on the circumference of the balancing disc. With two sides for loading the amount of unbalance, the balancing disc is made of 45 #steel.

The HZ-6J/Q brake having the rated torque of 6 N·M and the maximum rotational speed of 15,000 rpm is used in the embodiment. There are the short-time working mode and the continuous working mode. The brake has a power of 2,300 W every 5 min in the short-time working mode and a power of 2,000 W in the continuous working mode, with the torque tolerance being 0.2%. It includes a torque loader and a programmable loader. The brake can control the rotor system when the motor 1 is ineffective. Furthermore, the brake can implement fault simulation during acceleration and deceleration of the rotor system.

The impeller 8 is the four-blade impeller with the stable structure and easy installation, and can simulate the coupling of the impeller-rotating shaft system.

The sliding bearing 4 is provided on the bearing seat 3. Framework seal rings located on two sides of the sliding bearing are provided on the bearing seat 3, for fear of oil leakage.

The sliding bearing 4 in the embodiment includes a circular or elliptical bearing shell, the bearing shell includes an upper bearing shell and a lower bearing shell 401 that are opposite to each other, a groove 402 is formed at a bottom of the lower bearing shell 401, the groove 402 is provided horizontally along an axial direction of the lower bearing shell and provided symmetrically relative to a center of the lower shaft shell, a length of the groove 402 is ½-⅔ times a length of the lower shaft shell 401 and preferably ⅔ times the length of the lower bearing shell, two sides of the groove 402 form an included angle of 90° in a width direction relative to a center of the sliding bearing, and the groove is 0.2-0.5 mm deep. By providing the groove structure at the bottom of the bearing shell and optimizing the size of the groove, the specific pressure between the journal of the rotating shaft and the bearing shell can be greatly increased by 15-20%, and the relative eccentricity of the journal in the bearing shell can be significantly increased, all of which ensure the operational stability of the rotor bearing system on the test platform and the operational stability of the rotating shaft, and further make the data acquired more accurately.

The upper bearing shell and the lower bearing shell each are of a combined structure, the upper bearing shell and the lower bearing shell each include an initial section 403, an end filling section 404 and at least one middle filling section 405, and the middle filling section 405 is cooperatively provided between the initial section 403 and the end filling section 404. With the combined structure of the bearing shell, the length of the bearing shell can be adjusted to change the specific pressure, so as to effectively prevent the oil film resonance region and ensure the operational stability of the system and the reliability of the results in the simulation tests. In the lower bearing shell of the combined structure, the groove may be formed at the bottom of each section or the groove is formed in each of the initial section and the end filling section, or the groove is only formed in the initial section.

Preferably, a connection locating structure is cooperatively provided between the initial section 403, the end filling section 404 and the middle filling section 405; and the initial section 403, the end filling section 404 and the middle filling section 405 are connected with each other through the connection locating structure. The connection locating structure includes limiting grooves 407 at one end of the initial section, connection clamping pieces 406 at one end of the end filling section 404, and limiting grooves 407 and connection clamping pieces 406 that are respectively provided at two ends of the middle filling section 405; the limiting grooves 407 are oppositely arranged on inner and outer side of the bearing shell; the connection clamping pieces 406 each include two opposite clamping pieces; and the clamping pieces are correspondingly and cooperatively provided in the limiting grooves 407. A connecting hole is correspondingly formed in each of the connection clamping pieces and the limiting grooves; and a connecting pin is correspondingly provided in the connecting hole to fixedly connect the initial section, the end filling section and the middle filling section. A rubber pad is respectively provided between the connection clamping pieces and the limiting grooves to fill a clearance therebetween, thereby effectively ensuring the connection stability for each section of the bearing shell.

The data acquisition system is configured to acquire operation state data of the rotating shaft, and includes a multi-channel data acquisition unit, a rotational speed sensor for detecting a rotational speed of the motor, a vibration sensor for acquiring vibration data of the rotating shaft and a displacement sensor assembly for testing a displacement of the rotating shaft in an X direction and a Y direction.

The multi-channel data acquisition unit includes 16 analog input (AI) channels (internally provided with the anti-aliasing filter) and two digital input (DI) channels. A variety of data such as acceleration, speed, displacement, voltage, current, pressure, temperature and keyphase can be input to the input channels, so as to receive multiple signals of the sensor at the same time.

In the embodiment, the rotational speed sensor is used to monitor the output rotational speed of the motor to prevent the failure of the motor. The rotational speed sensor is the SZCB-05 rotational speed sensor that acquires the rotating signals with the principles of photoelectric reflection and features the high resolution, far distance, wide frequency response and high reliability. An amplifying and shaping circuit is provided in the sensor. The sensor outputs the stable square-wave signals and is mainly applied to measuring the rotational speed, cycle and speed in harsh test environments with violent vibrations.

The control system is configured to receive the data acquired by the data acquisition system, analyze and process the data, and control the test platform according to an analysis result.

The present disclosure further relates to a single or multi-coupled fault diagnosis method for a rotor system, including the following steps:

1) Test operation state data of the rotor system in a normal condition and different fault conditions, draw an operation graph, and establish different fault state determination models, including a rotating shaft crack fault determination model, a shafting thermal deformation fault determination model, and a coupling crack fault determination model.

The rotating shaft crack fault determination model is established as follows:
Z1: Mount a normal uncracked rotating shaft on a test platform, and provide a vibration sensor and displacement sensors, where the vibration sensor is magnetically fixed on a bearing seat, two displacement sensors are arranged at each sampling site, and the two sensors are respectively arranged along a horizontal direction and a vertical direction, and configured to detect displacement data of the rotating shaft in an X direction and a Y direction.
Z2: Start a motor, accelerate the rotating shaft at a constant speed to a critical rotational speed of a test system, and acquire vibration data of the sensor upon a stable rotational speed.
Z3: Adjust a torque of a brake, uniformly adjust the rotational speed of the rotating shaft, keep the test system at about a half of the critical rotational speed, adjust the rotational speed of the rotating shaft at a variable ΔV, and acquire vibration data at different rotational speeds.
Z4: Mount a cracked shaft, which is prefabricated with a crack, on the test platform and repeat Steps Z2 and Z3.
Z5: Analyze acquired data to obtain a vibration curve and an axis trajectory curve of each of the normal shaft and the cracked shaft, and compare the normal shaft with the cracked shaft in terms of the vibration curve and the axis trajectory curve, thereby establishing the rotating shaft crack fault determination model.

The shafting thermal deformation fault determination model is established as follows:
R1: Mount a rotating shaft on the test platform, and provide a heating jacket on a middle of the rotating shaft, where the heating jacket has a heating length of 100-200 mm, a 0.5-1 mm clearance is formed between the heating jacket and the rotating shaft, and a high-temperature resistant insulating oil is filled in the clearance.
R2: Respectively provide a data sampling site at two ends and a heating section of the rotating shaft, and respectively provide a vibration sensor and displacement sensors at the sampling site, where the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction.
R3: Start the motor and the heating jacket, keep the rotating shaft rotating for 15-20 min continuously after the heating jacket is heated to a preset temperature, and heat the heating section of the rotating shaft to a preset temperature.
R4: Acquire vibration and displacement data of the rotating shaft, and measure a deformation of the heating section of the rotating shaft.
R5: Adjust a temperature setting of the heating jacket, set an initial temperature T1, adjust a heating temperature with a temperature gradient ΔT as a variable, and repeat Steps R3 and R4.
R6: Analyze acquired data to obtain deformations, vibrations and axis trajectory curves of the rotating shaft at different temperatures, thereby establishing the shafting thermal deformation fault determination model.

The coupling crack fault determination model is established as follows:
L1: Mount a rotating shaft on the test platform, the rotating shaft being connected with an output shaft of the motor through a normal coupling.
L2: Respectively provide a data sampling site at two ends of the rotating shaft and a position where the coupling is provided; respectively provide a vibration sensor and displacement sensors at the sampling site, where the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction; and provide a rotational speed sensor between the output shaft of the motor and the coupling, so as to acquire a rotational speed signal and perform feedback control on the rotating shaft of the motor.
L3: Start the motor, accelerate the rotating shaft at a constant speed to the critical rotational speed of the test system, and acquire detection data upon a stable rotational speed.
L4: Adjust a torque of the brake, uniformly adjust the rotational speed of the rotating shaft, adjust the rotational speed of the rotating shaft at a variable ΔV until the test system is kept at about the half of the critical rotational speed, and acquire data at different rotational speeds.
L5: Connect the rotating shaft and the output shaft of the motor with a crack prefabricated coupling, and repeat Steps L2, L3 and L4.
L6: Analyze acquired data to obtain a vibration curve and an axis trajectory curve of each of the normal shaft and the crack prefabricated coupling, and compare the normal shaft with the crack prefabricated coupling in terms of the vibration curve and the axis trajectory curve, thereby establishing the coupling crack fault determination model.

2) Acquire an operation parameter of the rotor system in real time when the rotor system operates, comparatively analyze the operation parameter with the established fault state determination models, warn a fault of the rotor system, and determine and predict a fault type of the rotor system.

With the establishment of the fault determination models of the rotor system in the different fault conditions, the present disclosure can accurately predict and warn the fault of the rotor system, accurately analyze the fault type, and ensure the operational reliability of the rotor system. Specific embodiments are used herein for illustration of the principles and implementations of the disclosure. The above description of the embodiments is only intended to help understand the method of the disclosure and its core ideas. Moreover, those of ordinary skill in the art can make various modifications to specific implementations and scope of application in accordance with the concepts of the disclosure. In conclusion, the content of this specification shall not be construed as a limitation to the present disclosure.

1. A single or multi-coupled fault test system for a rotor system, comprising:
a test platform, configured to test performance of a rotating shaft, and comprising a mounting platform, a motor, a coupling, a bearing seat, a sliding bearing, a balancing disc, a heating jacket, a brake and an impeller, wherein the coupling is a film coupling and is configured to connect the rotating shaft with the motor and the brake; the sliding bearing is provided on the bearing seat, the sliding bearing comprises a circular or elliptical bearing shell, the bearing shell comprises an upper bearing shell and a lower bearing shell that are opposite to each other, a groove is formed at a bottom of the lower bearing shell, the groove is provided horizontally along an axial direction of the lower bearing shell and provided symmetrically relative to a center of the lower shaft shell, a length of the groove is ½-⅔ times a length of the lower shaft shell, two sides of the groove form an included angle of 90° in a width direction relative to a center of the sliding bearing, and the groove is 0.2-0.5 mm deep; and the upper bearing shell and the lower bearing shell each are of a combined structure, the upper bearing shell and the lower bearing shell each comprise an initial section, an end filling section and/or at least one middle filling section, and the middle filling section is cooperatively provided between the initial section and the end filling section;
a data acquisition system, configured to acquire operation state data of the rotating shaft, and comprising a multi-channel data acquisition unit, a rotational speed sensor for detecting a rotational speed of the motor, a vibration sensor for acquiring vibration data of the rotating shaft and a displacement sensor assembly for testing a displacement of the rotating shaft in an X direction and a Y direction; and
a control system, configured to receive the data acquired by the data acquisition system, analyze and process the data, and control the test platform according to an analysis result.

2. The single or multi-coupled fault test system for a rotor system according to claim 1, wherein a connection locating structure is cooperatively provided among the initial section, the end filling section and the middle filling section; the initial section, the end filling section and the middle filling section are connected with each other through the connection locating structure; the connection locating structure comprises limiting grooves and connection clamping pieces that are respectively arranged at one end of the initial section and at one end of the end filling section as well as at two ends of the middle filling section; the limiting grooves are oppositely arranged on inner and outer sides of the bearing shell; the connection clamping pieces each comprise two opposite clamping pieces; and the clamping pieces are correspondingly and cooperatively arranged in the limiting grooves.

3. A single or multi-coupled fault diagnosis method for a rotor system, comprising:
1) testing operation state data of the rotor system in a normal condition and different fault conditions, drawing an operation graph, and establishing different fault state determination models, comprising a rotating shaft crack fault determination model, a shafting thermal deformation fault determination model, and a coupling crack fault determination model, wherein
the establishing the rotating shaft crack fault determination model comprises:
Z1: mounting a normal uncracked rotating shaft on a test platform, and providing a vibration sensor and displacement sensors, wherein the vibration sensor is magnetically fixed on a bearing seat, two displacement sensors are arranged at each sampling site, and the two sensors are respectively arranged along a horizontal direction and a vertical direction, and configured to detect displacement data of the rotating shaft in an X direction and a Y direction;
Z2: starting a motor, accelerating the rotating shaft at a constant speed to a critical rotational speed of a test system, and acquiring vibration data of the sensor upon a stable rotational speed;
Z3: adjusting a torque of a brake, uniformly adjusting the rotational speed of the rotating shaft, keeping the test system at about a half of the critical rotational speed, adjusting the rotational speed of the rotating shaft at a variable ΔV, and acquiring vibration data at different rotational speeds;
Z4: mounting a cracked shaft, which is prefabricated with a crack, on the test platform and repeating steps Z2 and Z3; and
Z5: analyzing acquired data to obtain a vibration curve and an axis trajectory curve of each of the normal shaft and the cracked shaft, and comparing the normal shaft with the cracked shaft in terms of the vibration curve and the axis trajectory curve, thereby establishing the rotating shaft crack fault determination model;
the establishing the shafting thermal deformation fault determination model comprises:
R1: mounting a rotating shaft on the test platform, and providing a heating jacket on a middle of the rotating shaft, wherein the heating jacket has a heating length of 100-200 mm, a 0.5-1 mm clearance is formed between the heating jacket and the rotating shaft, and a high-temperature resistant insulating oil is filled in the clearance;
R2: respectively providing a data sampling site at two ends and a heating section of the rotating shaft, and respectively providing a vibration sensor and displacement sensors at the sampling site, wherein the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction;
R3: starting the motor and the heating jacket, keeping the rotating shaft rotating for 15-20 min continuously after the heating jacket is heated to a preset temperature, and heating the heating section of the rotating shaft to a preset temperature;
R4: acquiring vibration and displacement data of the rotating shaft, and measuring a deformation of the heating section on the rotating shaft;
R5: adjusting a temperature setting of the heating jacket, setting an initial temperature T1, adjusting a heating temperature with a temperature gradient ΔT as a variable, and repeating steps R3 and R4; and
R6: analyzing acquired data to obtain deformations, vibrations and axis trajectory curves of the rotating shaft at different temperatures, thereby establishing the shafting thermal deformation fault determination model; and
the establishing the coupling crack fault determination model comprises:
L1: mounting a rotating shaft on the test platform, the rotating shaft being connected with an output shaft of the motor through a normal coupling;
L2: respectively providing a data sampling site at two ends of the rotating shaft and a position where the coupling is provided; respectively providing a vibration sensor and displacement sensors at the sampling site, wherein the vibration sensor is magnetically fixed, two displacement sensors are arranged at each sampling site, and the two sensors are respectively arranged along a horizontal direction and a vertical direction, and configured to detect displacement data of the rotating shaft in an X direction and a Y direction; and providing a rotational speed sensor between the output shaft of the motor and the coupling, so as to acquire a rotational speed signal and perform feedback control on the rotating shaft of the motor;
L3: starting the motor, accelerating the rotating shaft at a constant speed to the critical rotational speed of the test system, and acquiring detection data upon a stable rotational speed;
L4: adjusting a torque of the brake, uniformly adjusting the rotational speed of the rotating shaft, adjusting the rotational speed of the rotating shaft at a variable ΔV until the test system is kept at about the half of the critical rotational speed, and acquiring data at different rotational speeds;
L5: connecting the rotating shaft and the output shaft of the motor with a crack prefabricated coupling, and repeating steps L2, L3 and L4; and
L6: analyzing acquired data to obtain a vibration curve and an axis trajectory curve of each of the normal shaft and the crack prefabricated coupling, and comparing the normal shaft with the crack prefabricated coupling in terms of the vibration curve and the axis trajectory curve, thereby establishing the coupling crack fault determination model; and
2) acquiring an operation parameter of the rotor system in real time when the rotor system operates, comparatively analyzing the operation parameter with the established fault state determination models, warning a fault of the rotor system, and determining and predicting a fault type of the rotor system.
